(19) United States
(12) Patent Application Publication
(10) Pub. No.: US 2016/0179349 A1
(43) Pub. Date: Jun. 23, 2016

(54) INFORMATION PROCESSING APPARATUS, INFORMATION PROCESSING METHOD, AND PROGRAM

(71) Applicant: SONY CORPORATION, Tokyo (JP)

(72) Inventors: Tsuyoshi ISHIKAWA, Kanagawa (JP); Takuya NAMAE, Kanagawa (JP); Daisuke MATSUMOTO, Kanagawa (JP); Kenji HISANAGA, Tokyo (JP)

(21) Appl. No.: 14/907,550

(22) PCT Filed: Jun. 25, 2014
(86) PCT No.: PCT/JP2014/003399

§ 371 Date: Jan. 25, 2016

(30) Foreign Application Priority Data
Jul. 31, 2013 (JP) 2013-158811

(51) Int. Cl. G06F 3/0484; G06T 11/60; G06T 11/00; G06F 3/0482; G06F 17/24; G06T 3/40; G06F 3/0483; G06T 1/00

(52) U.S. Cl. CPC G06F 3/04845; G06F 3/0483; G06F 3/04842; G06T 11/60; G06T 1/0007; G06F 3/0482; G06F 17/24; G06T 3/40; G06T 11/001

(57) ABSTRACT

There is provided an information processing apparatus including a circuitry configured to initiate a displaying of a content upon a display, and initiate an insertion of an acquired image into a region of the displayed content, the acquired image being selected on a basis of at least one image of a plurality of successive images that has been acquired and displayed.

### CROSS REFERENCE TO RELATED APPLICATIONS

This application claims the benefit of Japanese Priority Patent Application JP 2013-158811 filed Jul. 31, 2013, the entire contents of which are incorporated herein by reference.

### TECHNICAL FIELD

The present disclosure relates to an information processing apparatus, an information processing method, and a program.

### BACKGROUND ART

There is a technology which, in place of an existing book made of a paper medium, distributes the content of a book to a user terminal, such as a smartphone, as electronic book content (electronic data) so as to enable the content of the book to be viewed on the user terminal.

### CITATION LIST

### Patent Literature

### [PTL 1]

JP 2011-108118A

### SUMMARY

### Technical Problem

Meanwhile, there is also demand for a technology which, by providing the content of a book as electronic book content, not only makes it possible to view the content of the book in the same way as with an existing book made of a paper medium but also makes it possible to provide additional value that is difficult to obtain when the book is provided using a paper medium.

The present disclosure aims to provide a novel and improved information processing apparatus, information processing method, and program that are capable of reflecting user experiences in at least part of electronic book content.

### Solution to Problem

According to an aspect of the present disclosure, there is provided an information processing apparatus including a circuitry configured to: initiate a displaying of a content upon a display; and initiate an insertion of an acquired image into a region of the displayed content, the acquired image being selected on a basis of at least one image of a plurality of successive images that has been acquired and displayed.

According to another aspect of the present disclosure, there is provided an information processing method including: initiating a displaying of a content upon a display; and initiating an insertion of an acquired image into a region of the displayed content, the acquired image being selected on a basis of at least one image of a plurality of successive images that has been acquired and displayed.

According to another aspect of the present disclosure, there is provided a non-transitory computer-readable medium having embodied thereon a program, which when executed by a computer causes the computer to perform a method, the method including: initiating a displaying of a content upon a display; and initiating an insertion of an acquired image into a region of the displayed content, the acquired image being selected on a basis of at least one image of a plurality of successive images that has been acquired and displayed.

### Advantageous Effects of Invention

According to embodiments of the present disclosure described above, it is possible to provide an information processing apparatus, information processing method, and program that are capable of reflecting user experiences in at least part of electronic book content.

Note that the present disclosure is not limited to the effect stated above and in addition to or in place of the effect stated above, may achieve any of the effects indicated in this specification or effects that can be understood from the specification.

### BRIEF DESCRIPTION OF DRAWINGS

FIG. 1 is a diagram showing the overall system configuration of an information processing system according to an embodiment of the present disclosure.

FIG. 2 is an explanatory diagram of an example application of an information processing apparatus according to an embodiment of the present disclosure.

FIG. 3 is an explanatory diagram of another example application of an information processing apparatus according to an embodiment of the present disclosure.

FIG. 4 is a block diagram showing the configuration of the information processing apparatus according to an embodiment of the present disclosure.

FIG. 5 is a flowchart showing the flow of a series of processes by the information processing apparatus according to an embodiment of the present disclosure.

FIG. 6 is a block diagram showing an example hardware configuration of the information processing apparatus according to an embodiment of the present disclosure.

### DESCRIPTION OF EMBODIMENTS

Hereinafter, embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the following description is given in the order given below.

### 1. Overview

### 2. Configuration of Information Processing Apparatus

### 3. Processing

### 4. Example Hardware Configuration

### 5. Conclusion

### 1. OVERVIEW

### System Configuration

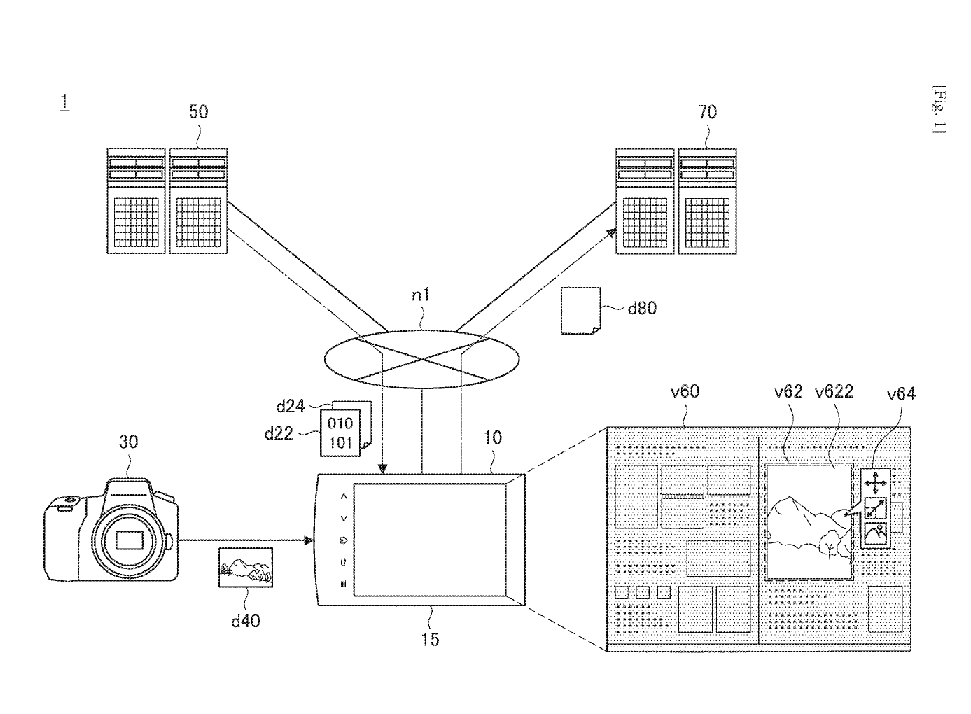

First, the overall system configuration of an information processing system 1 including an information processing apparatus 10 according to an embodiment of the present disclosure will be described with reference to FIG. 1. FIG. 1 is a diagram showing the overall system configuration of the information processing system 1 according to an embodiment. As shown in FIG. 1, the information processing system 1 includes the information processing apparatus 10, an image pickup apparatus 30, a content distribution server 50, and an external server 70.

The information processing apparatus 10, the content distribution server 50, and the external server 70 are configured so as to be capable of transmitting and receiving information between each other via a network n1. As examples, the network n1 is constructed of the Internet, dedicated lines, a LAN (Local Area Network), or a WAN (Wide Area Network). Note that provided the network can connect between different apparatuses, there are no limitations on the specification of the network n1.

The content distribution server 50 is a server for distributing electronic book content (hereinafter sometimes referred to as “electronic book content d24”) and an application d22 used to view the electronic book content d24 to the information processing apparatus 10. A server that provides the services of an online store or the like for selling the electronic book content d24 and/or the application d22 via a network such as the Internet can be given as a specific example of the content distribution server 50.

The image pickup apparatus 30 is a configuration for picking up images, and a digital camera can be given as a specific example of such configuration. The image pickup apparatus 30 picks up an image d40 based on control from the information processing apparatus 10 and outputs the picked-up image d40 to the information processing apparatus 10.

Note that the image pickup apparatus 30 may be incorporated in the information processing apparatus 10 or may be constructed as a separate housing to the information processing apparatus 10. If the image pickup apparatus 30 is constructed as a separate housing to the information processing apparatus 10, as one example, the image pickup apparatus 30 may be configured so that operations of the image pickup apparatus 30 are controlled based on instructions from the information processing apparatus 10.

The information processing apparatus 10 according to an embodiment acquires the electronic book content d24 from the content distribution server 50 and displays the acquired electronic book content d24 in a viewable manner via a display unit 15, which is a display or the like. As examples, the information processing apparatus 10 may be constructed of a smartphone, a tablet, or an electronic book terminal.

As one example, the information processing apparatus 10 accesses the content distribution server 50 via the network n1, and downloads and internally installs the application d22. By doing so, it is possible to add a function for viewing the electronic book content d24 to the information processing apparatus 10.

The information processing apparatus 10 then downloads the electronic book content d24 of an electronic book from the content distribution server 50. By running the installed application d22, the information processing apparatus 10 displays an article (content) included in the downloaded electronic book content d24 in a viewable manner on the display unit 15.

The electronic book content d24 may include a plurality of information decided in advance as information to be displayed (as examples, character information, and image information such as still images or moving images). Such plurality of information are respectively associated with one or more regions v62, and such one or more regions v62 are displayed as a page by being arranged based on a specified rules (a layout). Note that in the following description, out of the electronic book content d24, a series of data displayed on the display unit 15 as a page is also referred to as the “page data v60”.

The information processing apparatus 10 according to an embodiment is configured so that images picked up by the image pickup apparatus 30 can be disposed in one region v62 out of the page data v60 displayed on the display unit 15. Note that the information processing apparatus 10 will be separately described in detail later.

The external server 70 is a server for providing network services via the network n1. A social networking service (SNS) can be given as a specific example of such network services. As one example, by using the information processing apparatus 10 to access a network service provided by the external server 70 and to upload his/her own information, it is possible for the user of the information processing apparatus 10 to share information with other users registered on such network service. Note that so long as it is possible to share information with other users by uploading the information to the external server 70, the services provided by the external server 70 are not limited to social networking services.

Note that although an example where the application d22 and the electronic book content d24 are provided as separate data has been described above, it is also possible to use a configuration where the application d22 is embedded inside the electronic book content d24. The function that disposes images picked up by the image pickup apparatus 30 in the one region v62 in the page data v60 described earlier may be provided by the application d22 together with the function for viewing the electronic book content d24.

Also, the method of providing the application d22 and/or the electronic book content d24 is not limited to distribution from the content distribution server 50. As specific examples, the application d22 may be installed in advance in the information processing apparatus 10 and the electronic book content d24 may be stored in advance in the information processing apparatus 10 (that is, the application d22 and/or electronic book content d24 may be preinstalled). The application d22 and/or the electronic book content d24 may also be provided by using, as a medium, a secondary storage apparatus, such as an optical disk or an SD memory card, that is capable of nonvolatile storage of data.

### Example Application

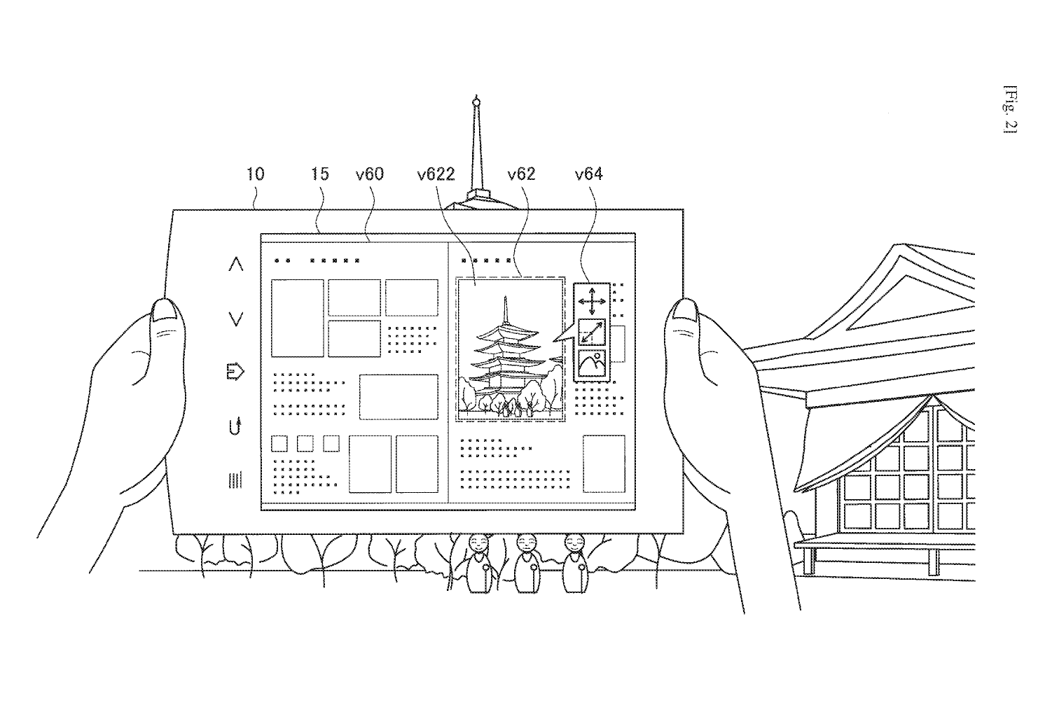

Next, a state where an image d40 that has been picked up by the image pickup apparatus 30 is disposed in one region v62 in the page data v60 will be described with reference to FIG. 2 as a specific example application of the information processing apparatus 10 according to an embodiment. FIG. 2 is an explanatory diagram of an example application of the information processing apparatus 10 according to an embodiment.

FIG. 2 shows an example of a case where a travel magazine is provided as the electronic book content d24. As one example, many photographs (images) such as famous tourist spots are incorporated in the electronic book content d24 of the travel magazine.

As one example, by downloading the electronic book content d24 to the information processing apparatus 10, the user (that is, the reader of the electronic book content d24) is capable, while referring to the electronic book content d24 via the information processing apparatus 10, of visiting a place shown in the electronic book content d24.

Also, the information processing apparatus 10 according to an embodiment is capable of designating one region v62 in the page data v60 displayed on the display unit 15 and of disposing an image d40 picked up by the image pickup apparatus 30 incorporated in the information processing apparatus 10 for example in such region(s) v62.

More specifically, the information processing apparatus 10 according to an embodiment displays a desired region v62, out of the one or more regions v62 included in the page data v60 of the electronic book content d24, in a selectable manner. If the user has selected one region v62 out of the displayed page data v60 (for example, a region in which a photograph of a visited place has been inserted), the information processing apparatus 10 activates the image pickup apparatus 30 and has images, which are successively acquired based on an image pickup process carried out by the image pickup apparatus 30, displayed as preview images in the selected region v62. By using this configuration, a part of the page data v60 aside from the selected region v62 becomes a frame and images successively acquired based on an image pickup process by the image pickup apparatus 30 are displayed inside such frame.

That is, according to the information processing apparatus 10, it is possible for the user to give an image pickup instruction to the information processing apparatus 10 while checking the page data v60 where an image based on an image pickup process by the image pickup apparatus 30 has been disposed in a desired region v62 in the page data v60. Note that by displaying an instruction interface v64 for designating an enlargement ratio or the content of image processing, the information processing apparatus 10 may enable the user to designate the enlargement ratio or the content of image processing (for example, grayscale or sepia processing).

On receiving an image pickup instruction from the user, the information processing apparatus 10 acquires an image picked up by the image pickup apparatus 30 at the timing when the image pickup instruction was received and disposes the acquired image in the selected region v62 in the page data v60. The information processing apparatus 10 then records the page data v60 in which the acquired image has been disposed as editing data.

By using this configuration, the user is capable of generating and viewing editing data where an image picked up by the user himself/herself has been disposed inside a layout into which the electronic book content d24 has been arranged. In other words, according to the information processing apparatus 10 according to an embodiment, it is possible to reflect, as an experience of the user, images picked up by the user in the content provided by the electronic book content d24.

The information processing apparatus 10 may also be configured so as to be able to upload an image that has been picked up based on an image pickup instruction as upload data d80 to a network service such as an SNS. When doing so, the information processing apparatus 10 may be capable of automatically generating, as part of the upload data d80 and based on information embedded in advance in the page data v60 that was being displayed when the image pickup instruction was received, information such as a comment to be appended to an uploaded image. As one example, the information processing apparatus 10 may generate the upload data d80 by associating the picked up image with an explanation of a spot inserted as information on the page data v60, a map of the vicinity of such spot, and information on events or the like to be held at such spot.

By using this configuration, according to the information processing apparatus 10 according to an embodiment, it is possible to reduce the burden of the user in generating other data aside from a picked-up image when uploading a picked-up image to a network service.

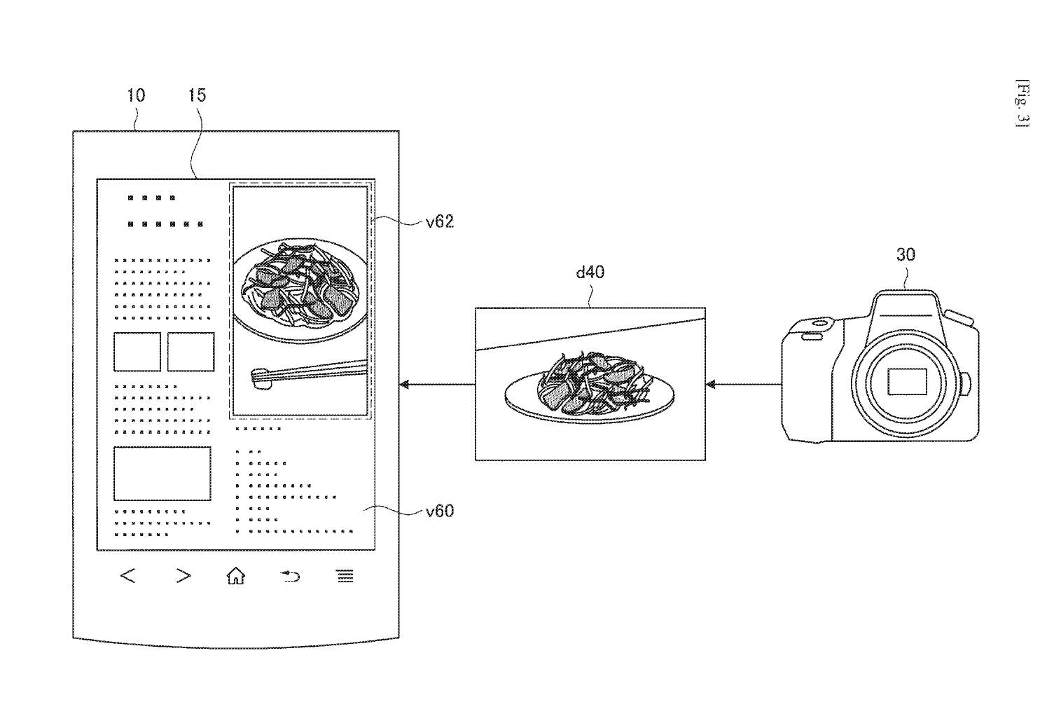

Also, the field to which the information processing apparatus 10 according to an embodiment is applied is not limited to the electronic book content d24 for a travel magazine. As one example, FIG. 3 is an explanatory diagram of another example application of the information processing apparatus 10 according to an embodiment, and shows a case where the information processing apparatus 10 is applied to the electronic book content d24 of a cookery magazine.

As one example, in the example shown in FIG. 3, it is possible for the user to prepare a dish while viewing, via the user's information processing apparatus 10, a recipe for the dish which is inserted as page data v60 in the electronic book content d24 of a cookery magazine.

The user may then designate a region v62 where an image of the dish has been inserted into the page data v60 displayed on the information processing apparatus 10, and pick up a photograph of the dish prepared by the user himself/herself with a part of the page data v60 aside from the selected region v62 as a frame. With this configuration, it is possible for example to reflect an image of a dish prepared by the user as an experience of the user in the electronic book content d24 in which an image of a dish and the recipe of such dish have been inserted. The user is also capable of uploading an image of the dish prepared by the user himself/herself together with information on the recipe inserted in the page data v60 to a network service as the upload data d80.

Also, the information associated with the each region v62 is not limited to fixed information that is decided in advance and as one example may be information that varies according to an input of a parameter decided in advance. As a specific example, the information processing apparatus 10 may operate so that a message or comment is changed with a date, a time slot, a day of the week, or the like as an input parameter. As another example, the information processing apparatus 10 may operate so as to acquire position information produced by GPS or the like, to acquire a map of the vicinity based on the acquired position information, and associate the acquired information with a picked-up image.

Note that the function described above may be provided as one function of the application d22 for viewing the electronic book content d24 or a program or script for realizing the function described above may be embedded in the electronic book content d24 itself.

### 2. CONFIGURATION OF INFORMATION PROCESSING APPARATUS

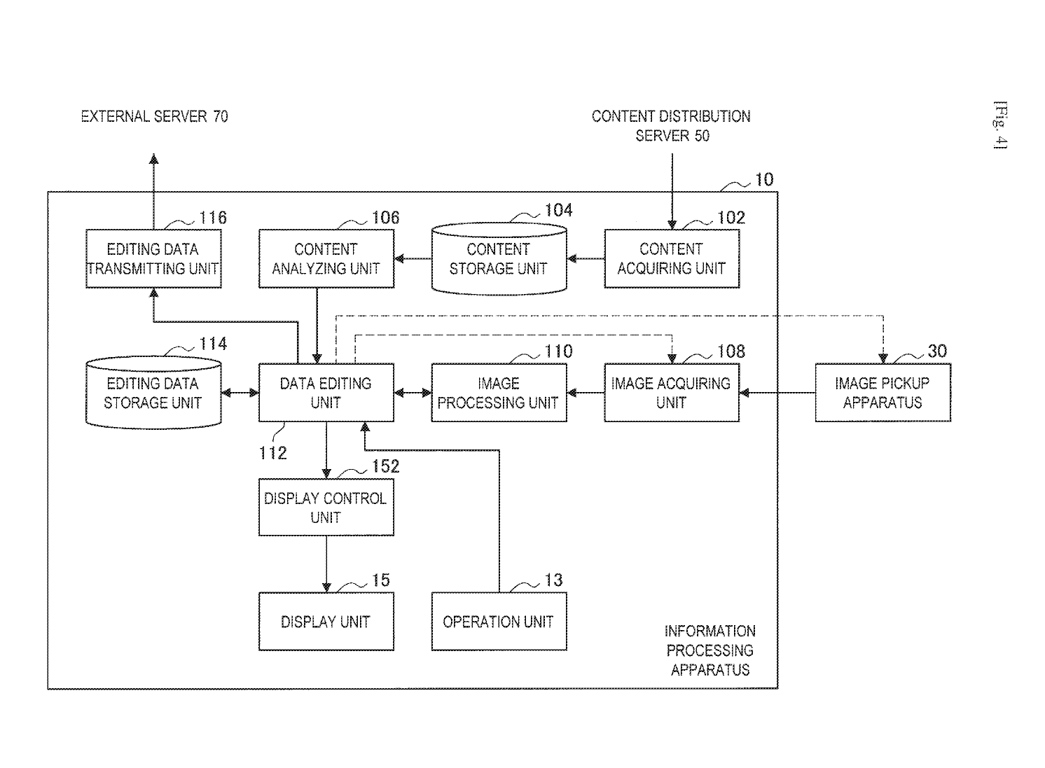

Next, the configuration of the information processing apparatus 10 according to an embodiment will be described with reference to FIG. 4. FIG. 4 is a block diagram showing the configuration of the information processing apparatus 10 according to an embodiment. As shown in FIG. 4, the information processing apparatus 10 includes a content acquiring unit 102, a content storage unit 104, a content analyzing unit 106, an image acquiring unit 108, an image processing unit 110, a data editing unit 112, a display control unit 152, a display unit 15, an operation unit 13, an editing data storage unit 114, and an editing data transmitting unit 116.

Note that when describing the various parts of the configuration of the information processing apparatus 10 according to an embodiment, first the configuration of the electronic book content d24 according to an embodiment will be described and then the various parts of the configuration of the information processing apparatus 10 will be described. Also, the configuration of the information processing apparatus 10 will be described split into a “display process” for displaying the electronic book content d24, an “editing process” that disposes an image picked up by the image pickup apparatus 30 in part of the electronic book content d24, and a “transmission process” that uploads the picked-up image to a network service, focusing on the parts of the configuration that operate in each of such cases.

### Configuration of Electronic Book Content

For the electronic book content d24 according to an embodiment, a plurality of information to be displayed (that is, information to be viewed by the reader) are each associated with respective regions out of one or more regions v62, and such one or more regions v62 are displayed as a page (that is, the page data v60) by being arranged based on predetermined rules (a layout). Note that the electronic book content d24 may include a plurality of page data v60.

Also, it is desirable for the electronic book content d24 according to an embodiment to be provided in a fixed layout type. Such fixed layout type is a format where various regions v62 included in the electronic book content d24 are displayed as the page data v60 having been arranged based on rules (a layout) decided in advance regardless of the device in use and the setting of the character size.

However, if any of the information to be displayed in the electronic book content d24 is displayed associated with a region v62 and it is possible to dispose a picked-up image in such region v62, the format of the electronic book content d24 is not limited to a fixed layout type. As one example, the electronic book content d24 may be provided in a reflow layout type where the layout is changed in accordance with the device in use and the setting of the character size. When a reflow layout type is used, it is sufficient to dispose the picked-up image in a region (such as a region in which an image like an illustration is displayed) whose form and size does not change even when the layout has changed due to a change in the settings of the character size or the like.

Also, out of the one or more regions v62, at least one region v62 may be associated with another region v62. As a specific example, for an electronic book content d24 for a travel magazine, a region v62 associated with a photograph of a certain tourist spot may be associated with another region v62 in which a description of such tourist spot is written. As another example, for an electronic book content d24 for a cookery magazine, a region v62 associated with a photograph of a certain dish may be associated with another region v62 in which the recipe of such dish is written.

Also, out of the one or more regions v62, at least one region v62 may be associated with other information aside from the information that is to be displayed. As a specific example, a region v62 associated with a photograph may be associated with a template for generating a comment for such photograph. As one example, such template may be generated in advance in accordance with the subject or theme of the photograph associated with such region v62. Also, a region v62 associated with a photograph or description of a theme park or the like may be associated with information relating to the subject of such photograph, such as an illustration of a mascot of such theme park.

Note that the detailed processing based on information associated with the respective regions v62 is separately described later together with the description of the configuration relating to the “editing process”.

### Display Process

Next, out of the configuration of the information processing apparatus 10, the configuration relating to a process for displaying the electronic book content d24 will be described.

The content acquiring unit 102 accesses the content distribution server 50 via the network n1 and acquires the electronic book content d24 from the content distribution server 50. The content acquiring unit 102 stores the acquired electronic book content d24 in the content storage unit 104. The content storage unit 104 is a storage unit for storing the electronic book content d24.

At this time, if the application d22 for viewing the electronic book content d24 has not been installed in the information processing apparatus 10, the content acquiring unit 102 may acquire the application d22 from the content distribution server 50. If the content acquiring unit 102 has acquired the application d22, as one example, a processing unit (not shown) of the information processing apparatus 10 may be caused to operate so as to install the acquired application d22 in the information processing apparatus 10.

The content analyzing unit 106 reads the electronic book content d24 from the content storage unit 104. By analyzing the read electronic book content d24, the content analyzing unit 106 converts the electronic book content d24 to data that enables the respective regions v62 and the information associated with such regions v62 (that is, information to be displayed and other information that is not to be displayed) that are included in the electronic book content d24, to be read and edited. As a specific example, by structuring various data inside the electronic book content d24, the content analyzing unit 106 may convert to data that enables the regions v62 and the information associated with such regions v62 that are included in such electronic book content d24, to be read and edited.

The content analyzing unit 106 outputs the electronic book content d24 after analysis to the data editing unit 112. Note that the electronic book content d20 may be provided from the content distribution server 50 as data that has already been analyzed. It should be obvious that if the electronic book content d20 is provided as analyzed data, the content analyzing unit 106 does not need to be provided. In this case, the data editing unit 112, described later, may read the electronic book content d20 from the content storage unit 104. Also, in the following description, even when the simple expression “electronic book content d24” is used, it is assumed that the electronic book content d24 processed by the data editing unit 112 is the electronic book content d24 after analysis.

The data editing unit 112 acquires the electronic book content d24 from the content analyzing unit 106. The data editing unit 112 specifies a page to be displayed based on settings related to the display of the electronic book content d24 decided in advance and outputs the page data v60 of the specified page to the display control unit 152. Note that a setting of the page data v60 to be displayed first and a setting of an enlargement ratio or the like when displaying the page data v60 may be given as examples of settings relating to the displaying of the electronic book content d24.

The display control unit 152 displays the page data v60 acquired from the data editing unit 112 on the display unit 15. By doing so, it is possible for the user to refer to the content of the page data v60 via the display unit 15.

Also, the data editing unit 112 receives, from the operation unit 13, control information showing the content of a user operation of the page data v60 performed via such operation unit 13. As one example, the data editing unit 112 receives control information showing the content of an operation relating to a page turn, that is, an operation relating to a change in the page to be displayed, from the operation unit 13. In this case, the data editing unit 112 specifies, based on the control information acquired from the operation unit 13, the page to be newly displayed and outputs the page data v60 of the specified page to the display control unit 152. The display control unit 152 displays the new page data v60 acquired from the data editing unit 112 on the display unit 15. By doing so, the user is capable of referring, via the display unit 15, to the content of the page data v60 after the change.

The display unit 15 is a display device for displaying the content (that is, the page data v60) of the electronic book content d24. A display of the information processing apparatus 10 can be given as a specific example of the display unit 15.

The operation unit 13 is an input interface that enables the user to operate the information processing apparatus 10. A pointing device that designates information displayed on the display unit 15 and a button or buttons that is/are assigned specified functions in advance, and a touch panel can be given as specific examples of the operation unit 13. Note that in the following description, instructions based on operations made via the operation unit 13 are assumed for example to include both instructions based on an operation of a button or the like provided as hardware on the information processing apparatus 10 and instructions based on operations of an operation interface displayed on a screen.

### Editing Process

Next, out of the configuration of the information processing apparatus 10, the configuration relating to a process that disposes an image picked up by the image pickup apparatus 30 in part of the electronic book content d24 will be described.

The image acquiring unit 108 acquires, from the image pickup apparatus 30, images d40 that are successively picked up by the image pickup apparatus 30 at timing (frames) decided in advance. Note that the image acquiring unit 108 may successively acquire images d40 picked up by the image pickup apparatus 30 in synchronization with an image pickup operation by the image pickup apparatus 30. As one example, by displaying images successively acquired in synchronization with an image pickup operation by the image pickup apparatus 30, it is possible for the user to confirm the images d40 picked up by the image pickup apparatus 30 in real time.

Note that the image acquiring unit 108 may sort the images d40 into display images (that is, temporary images used as a preview) and recording images (that is, images to be recorded as data) and acquire such images separately according to respectively different conditions. As one example, the higher the resolution of the images picked up, the greater the load in transferring such images and in processing (such as rendering) such images. For this reason, as one example, the image acquiring unit 108 may acquire the display images with a lower image resolution than the recording images and acquire a recording image with a higher resolution than the display images when a separate image pickup instruction has been received. In the same way, the image pickup apparatus 30 may also be capable of changing the image pickup conditions for display images and recording images. Note that in the following description, it is assumed that the image acquiring unit 108 sorts into display images and recording images and acquires the respective images separately with respectively different conditions.

The source of control over operations of the image acquiring unit 108 may change as appropriate in accordance with the configuration of the information processing apparatus 10. As a specific example, the image acquiring unit 108 may start or end acquisition of images from the image pickup apparatus 30 based on an instruction from the data editing unit 112. Also, as another example, the image acquiring unit 108 may start or end acquisition of images from the image pickup apparatus 30 based on an instruction from the user made via the operation unit 13. Note that in the following description, it is assumed that the image acquiring unit 108 starts the acquisition of images based on an instruction from the data editing unit 112 and in the same way ends the acquisition of images based on an instruction from the data editing unit 112.

The image processing unit 110 acquires the image d40 from the image acquiring unit 108 and carries out image processing on the acquired image. Processing that changes the enlargement ratio such as a digital zoom process (in other words, a process that changes the display region) and processing that changes color information in an image (such as a grayscale) can be given as examples of the content of the image processing. The image processing unit 110 may also carry out a process, such as trimming, that cuts out a region that forms part of the image.

The image processing unit 110 outputs the image d40 on which image processing has been carried out to the data editing unit 112.

Note that it is not absolutely necessary for the image processing unit 110 to carry out image processing on the image d40 acquired from the image acquiring unit 108. As one example, the image processing unit 110 may output an image acquired from the image acquiring unit 108 as it is to the data editing unit 112.

The source of control over operations of the image processing unit 110 may also change as appropriate in accordance with the configuration of the information processing apparatus 10. As a specific example, the image processing unit 110 may carry out image processing on the image d40 acquired from the image acquiring unit 108 based on an instruction from the data editing unit 112. In this case, as one example, the data editing unit 112 may be configured to indicate a content of image processing, which has been designated by an operator via the operation unit 13, to the image processing unit 110. As another example, the image processing unit 110 may carry out image processing on the image d40 acquired from the image acquiring unit 108 based on an instruction from the user made via the operation unit 13. Note that in the following description, it is assumed that the image processing unit 110 carries out image processing on an image acquired from the image acquiring unit 108 based on an instruction from the data editing unit 112.

As one example, by receiving an instruction relating to editing of the page data v60 from the operator via the operation unit 13, the data editing unit 112 switches to operation in a mode (hereinafter sometimes referred to as “editing mode”) where an image picked up by the image pickup apparatus 30 is disposed in the displayed page data v60.

On receiving the switch to operation in editing mode, the data editing unit 112 instructs the image pickup apparatus 30 to start image pickup of display images and instructs the image acquiring unit 108 to acquire images from the image pickup apparatus 30. Based on such instructions, image pickup of display images is started by the image pickup apparatus 30 and display images that have been successively picked up by the image pickup apparatus 30 are successively acquired by the image acquiring unit 108. The display images successively acquired by the image acquiring unit 108 based on an image pickup operation being carried out by the image pickup apparatus 30 are successively outputted via the image processing unit 110 to the data editing unit 112. Note that at this time, the image processing unit 110 may carry out image processing on the acquired display images based on image processing settings that are decided in advance and output the images on which image processing has been carried out to the data editing unit 112.

Also, on receiving the switch to operation in editing mode, the data editing unit 112 sets the respective regions v62 in the page data v60 to be displayed as selectable and instructs the display control unit 152 to display such page data v60 on the display unit 15. By having the data editing unit 112 operate in this way, it becomes possible for the user to select, via the operation unit 13, one region v62 out of the regions v62 in the page data v60 displayed on the display unit 15. Note that the data editing unit 112 may set one region v62 out of the regions v62 in the page data v60 in an already selected state.

The data editing unit 112 that has received the selection of one region v62 out of the page data v60 being displayed disposes images successively acquired from the image processing unit 110 (that is, images acquired based on an image pickup operation by the image pickup apparatus 30) in such region(s) v62 in place of the information associated with the selected region(s) v62. The data editing unit 112 then outputs the page data v60 in which the images acquired from the image processing unit 110 have been disposed in the selected region(s) v62 to the display control unit 152. The display control unit 152 updates the page data v60 displayed on the display unit 15 to the page data v60 newly acquired from the data editing unit 112. By using this configuration, images successively acquired based on an image pickup operation being carried out by the image pickup apparatus 30 are displayed as preview images, for example, in the selected region(s) v62 in the page data v60 displayed on the display unit 15.

Note that the data editing unit 112 that has received the selection of the region(s) v62 in the page data v60 may associate, with such region(s) v62, an instruction interface v64 for indicating the content of image processing to be carried out on the images displayed in such region(s) v62. In this case, as one example the display control unit 152 may display the instruction interface v64 so that the association with the selected region(s) v62 in the page data v60 can be understood (for example, by displaying the instruction interface v64 in the vicinity of the selected region(s) v62.

Also, if the user has indicated the content of image processing via the operation unit 13 based on the displayed instruction interface v64, the data editing unit 112 acquires the content of image processing indicated from the user from the operation unit 13 and notifies the image processing unit 110 of the acquired content. On receiving such notification, the image processing unit 110 changes the content of the image processing on the images acquired from the image acquiring unit 108 to the notified content.

Also, if the content of the image processing indicated from the user changes the enlargement ratio, as with a zoom operation for example, the data editing unit 112 may change the enlargement ratio by controlling the image pickup apparatus 30.

With the configuration described above, the content of the image processing indicated from the user is reflected in the preview images displayed in the region(s) v62 of the page data v60. This means that it becomes possible for the user to give an image pickup instruction to the information processing apparatus 10 having adjusted the image pickup angle and/or the content of image processing while confirming the page data v60 where images based on image pickup by the image pickup apparatus 30 have been disposed in the desired region(s) v62 in the page data v60.

Also, on receiving an image pickup instruction from the user via the operation unit 13, the data editing unit 112 instructs the image pickup apparatus 30 to pick up a recording image and instructs the image acquiring unit 108 to acquire the recording image from the image pickup apparatus 30. Based on such instructions, a recording image is picked up by the image pickup apparatus 30 and the recording image picked up by the image pickup apparatus 30 is acquired by the image acquiring unit 108. In the same way as a display image, the recording image acquired by the image acquiring unit 108 is subjected to image processing by the image processing unit 110 and outputted to the data editing unit 112.

The data editing unit 112 generates editing data by disposing the recording image acquired from the image processing unit 110 in the selected region(s) v62 in the page data v60 being displayed. The data editing unit 112 stores the generated editing data and the acquired recording image in the editing data storage unit 114. The editing data storage unit 114 is a storage unit for storing recording images that have been picked up and editing data that has been generated.

Note that the recording images may be still images or moving images. If the recording images are acquired as moving images, as one example the data editing unit 112 may indicate a start and end of recording of moving images to the image pickup apparatus 30 and the image acquiring unit 108 and acquire the moving images picked up during such recording period as the recording images.

Also, the data editing unit 112 may associate information associated with the selected region(s) v62 in the page data v60 with the acquired recording images.

As one example, in the case of an electronic book content d24 for a travel magazine, a region v62 associated with a photograph of a certain tourist spot may be associated in advance with another region v62 in which a description of such tourist spot is written. By using this configuration, it is possible, when a photograph of such tourist spot inserted in the electronic book content d24 has been replaced with a recording image based on an image pickup operation by the image pickup apparatus 30, for the data editing unit 112 to associate the description of such tourist spot with the recording image.

Also, the information associated with the recording image is not limited to information to be displayed for the electronic book content d24. As a specific example, a region v62 associated with a photograph as display information may be associated with a template for generating a comment for such photograph.

Also, the information associated with the recording images is not limited to fixed information that is decided in advance. As one example, a program or script may be associated with a region v62 so that the data editing unit 112 switches the information (for example, a message or comment) associated with a recording image in accordance with image pickup conditions for a date, a time slot, or a day of the week when the recording image was picked up. As another example, a program or script may be associated with a region v62 so that the data editing unit 112 switches information (for example, map information) associated with a recording image in accordance with position information on the place where the recording image was picked up.

Note that details of processing that uses the information associated with the recording image will be described later together with the description of the configuration relating to the “transmission process”.

Also, the information processing apparatus 10 may be configured so that it is possible to change the page data v60 being displayed even in editing mode. In such case, as one example the data editing unit 112 receives control information showing the content of an operation relating to a page turn, that is, an operation relating to a change in the page to be displayed, from the operation unit 13. The data editing unit 112 specifies, based on the control information acquired from the operation unit 13, a page to be newly displayed. If a region v62 set in a selected state in advance is included in the page data v60 corresponding to a specified page, the data editing unit 112 may dispose an image acquired from the image processing unit 110 in such region v62. Also, in the case where a region v62 set in a selected state is not included, the data editing unit 112 may have the user select a region v62 once again.

Note that if an end of editing mode has been indicated by the user via the operation unit 13, the data editing unit 112 instructs the image pickup apparatus 30 to end image pickup of display images and instructs the image acquiring unit 108 to end the acquisition of images d40 from the image pickup apparatus 30. Based on such instructions, the image pickup apparatus 30 ends the processing relating to image pickup of display images. In the same way, the image acquiring unit 108 ends the processing relating to acquisition of the images d40 from the image pickup apparatus 30.

### Transmission Process

Next, out of the configuration of the information processing apparatus 10, the configuration relating to a process for uploading a picked up recording image to a network service, such as an SNS, as the upload data d80 will be described.

The information processing apparatus 10 according to an embodiment may also associate information, which was associated in advance with a region v62 in which a recording image is disposed, with such recording image and upload as the upload data d80 to a network service, such as an SNS.

More specifically, on receiving an instruction relating to the uploading of a recording image from the user via the operation unit 13, the data editing unit 112 reads the recording image in question from the editing data storage unit 114. The data editing unit 112 then generates the upload data d80 based on the read recording image and the information associated with such recording image.

At this time, if, for example, a template for generating a comment is associated with a recording image, the data editing unit 112 may automatically generate a comment based on the image pickup conditions (as examples, the image pickup date and/or image pickup location) of the recording image. It should be obvious that the data editing unit 112 may display an input interface for enabling the user to generate a comment based on such template on the display unit 15 via the display control unit 152. In such case, the data editing unit 112 may generate a comment based on information inputted from the user via the operation unit 13.

The data editing unit 112 may also display an input interface for designating information showing a network service that is an upload destination and authentication information for logging into such network service via the display control unit 152 on the display unit 15. In such case, the data editing unit 112 acquires, from the operation unit 13, the information showing the network service that is the upload destination and the authentication information for logging into such network service, both of which have been inputted from the user. Note that in the following description, the information showing the network service that is the upload destination and the authentication information for logging into such network service are sometimes referred to simply as “access information for a network service”.

Note that the data editing unit 112 may hold the acquired access information for a network service in a nonvolatile manner by storing such information in a specified storage apparatus. In such case, when accessing the network service again, the data editing unit 112 is capable of acquiring the access information for accessing such network service from the specified storage apparatus.

The data editing unit 112 outputs the generated upload data d80 and the acquired access information for the network service to the editing data transmitting unit 116.

The editing data transmitting unit 116 acquires the upload data d80 and the access information for the network service from the data editing unit 112. The editing data transmitting unit 116 establishes a connection with the network service (that is, the external server 70) via the network n1 based on the acquired access information for the network service. Once a connection with the network service (that is, the external server 70) has been established, the editing data transmitting unit 116 uploads the upload data d80 to the network service.

As described above, the information processing apparatus 10 according to an embodiment generates the upload data d80 based on the recording image(s) and information associated with such recording image(s) and uploads the generated upload data d80 to a network service. This means that when uploading the recording image(s) (that is, the picked up image(s)) to a network service, it is possible to reduce the burden of the user in generating other data, such as a comment, aside from the recording image(s).

Also, in the information processing apparatus 10 according to an embodiment, information associated with a region v62 in the page data v60 in which a recording image is disposed is further associated with such recording image. This means that according to the information processing apparatus 10 according to an embodiment, it is possible to automatically generate the upload data d80 in accordance with a content written as an article in the electronic book content d24.

### 3. PROCESSING

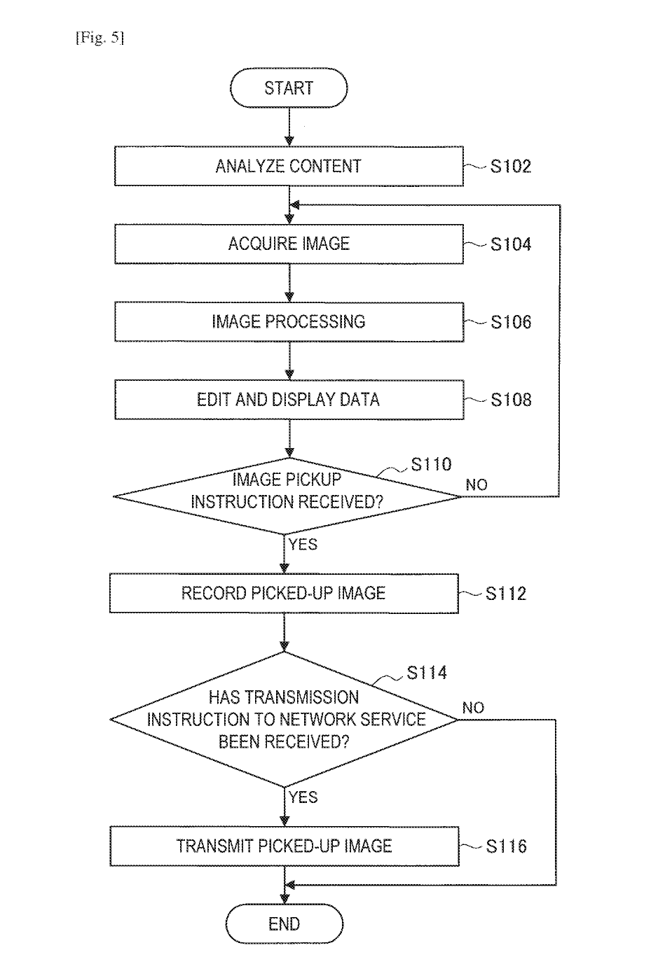

Next, a flow of a series of processes by the information processing apparatus 10 according to an embodiment will be described with reference to FIG. 5. FIG. 5 is a flowchart showing the flow of the series of processes by the information processing apparatus 10 according to an embodiment.

### Step S102

The content acquiring unit 102 accesses the content distribution server 50 via the network n1 and acquires the electronic book content d24 from the content distribution server 50. The content acquiring unit 102 stores the acquired electronic book content d24 in the content storage unit 104.

At this time, if the application d22 for viewing the electronic book content d24 has not been installed in the information processing apparatus 10, the content acquiring unit 102 may acquire the application d22 from the content distribution server 50. If the content acquiring unit 102 has acquired the application d22, as one example, a processing unit (not shown) of the information processing apparatus 10 may be caused to operate the information processing apparatus 10 so as to install the acquired application d22 in the information processing apparatus 10.

The content analyzing unit 106 reads the electronic book content d24 from the content storage unit 104. By analyzing the read electronic book content d24, the content analyzing unit 106 converts to data that enables the respective regions v62 and the information associated with such regions v62 (that is, information to be displayed and other information that is not to be displayed) that are included in the electronic book content d24, to be read and edited.

The content analyzing unit 106 outputs the electronic book content d24 after analysis to the data editing unit 112.

The data editing unit 112 acquires the electronic book content d24 from the content analyzing unit 106. The data editing unit 112 specifies a page to be displayed based on settings relating to the displaying of the electronic book content d24 decided in advance and outputs the page data v60 of the specified page to the display control unit 152. The display control unit 152 displays the page data v60 acquired from the data editing unit 112 on the display unit 15. By doing so, it is possible for the user to refer to the content of the page data v60 via the display unit 15.

### Step S104

As one example, by receiving an instruction relating to editing of the page data v60 from the operator via the operation unit 13, the data editing unit 112 switches to operation in a mode (hereinafter sometimes referred to as “editing mode”) where an image picked up by the image pickup apparatus 30 is disposed in the displayed page data v60.

On receiving the switch to operation in editing mode, the data editing unit 112 instructs the image pickup apparatus 30 to start image pickup of display images and instructs the image acquiring unit 108 to acquire images from the image pickup apparatus 30. Based on such instructions, image pickup of display images is started by the image pickup apparatus 30 and display images that have been successively picked up by the image pickup apparatus 30 are successively acquired by the image acquiring unit 108.

### Step S106

The display images successively acquired by the image acquiring unit 108 based on an image pickup operation being carried out by the image pickup apparatus 30 are successively outputted via the image processing unit 110 to the data editing unit 112. Note that at this time, the image processing unit 110 may carry out image processing on the acquired display images based on image processing settings that are decided in advance and output images on which image processing has been carried out to the data editing unit 112.

### Step S108

Also, on receiving the switch to operation in editing mode, the data editing unit 112 sets the respective regions v62 in the page data v60 to be displayed as selectable and instructs the display control unit 152 to display such page data v60 on the display unit 15. By having the data editing unit 112 operate in this way, it becomes possible for the user to select, via the operation unit 13, one region v62 out of the regions v62 in the page data v60 displayed on the display unit 15.

The data editing unit 112 that has received the selection of one region v62 out of the page data v60 being displayed disposes images successively acquired from the image processing unit 110 (that is, images acquired based on an image pickup operation by the image pickup apparatus 30) in such region(s) v62 in place of the information associated with the selected region(s) v62. The data editing unit 112 then outputs the page data v60 in which the images acquired from the image processing unit 110 have been disposed in the selected region(s) v62 to the display control unit 152. The display control unit 152 updates the page data v60 displayed on the display unit 15 to the page data v60 newly acquired from the data editing unit 112. By using this configuration, images successively acquired based on an image pickup operation being carried out by the image pickup apparatus 30 are displayed as preview images, for example, in the selected region(s) v62 in the page data v60 displayed on the display unit 15.

### Step S110

The data editing unit 112 successively acquires images based on an image pickup operation by the image pickup apparatus 30 until an image pickup instruction is received (step S110, No), and successively outputs the page data v60, where the acquired images have been disposed in the selected region(s) v62, to the display control unit 152. By doing so, the page data v60 displayed on the display unit 15 is updated in real time in synchronization with an image pickup operation by the image pickup apparatus 30.

Note that if the user has indicated the content of image processing via the operation unit 13, the data editing unit 112 may notify the image processing unit 110 of the content of the image processing indicated from the user. On receiving such notification, the image processing unit 110 changes the content of the image processing carried out on the images acquired from the image acquiring unit 108 to the notified content. By using this configuration, the information processing apparatus 10 according to an embodiment makes it possible to reflect, in real time, a content of the image processing indicated by the user on images displayed in the selected region(s) v62 in the page data v60 displayed on the display unit 15.

### Step S112

On receiving an image pickup instruction from the user via the operation unit 13 (step S110, Yes), the data editing unit 112 instructs the image pickup apparatus 30 to carry out image pickup of a recording image and instructs the image acquiring unit 108 to acquire the recording image from the image pickup apparatus 30. Based on such instructions, a recording image is picked up by the image pickup apparatus 30 and the recording image picked up by the image pickup apparatus 30 is acquired by the image acquiring unit 108. The recording image acquired by the image acquiring unit 108 is subjected to image processing by the image processing unit 110 and outputted to the data editing unit 112.

The data editing unit 112 generates editing data by disposing the recording image acquired from the image processing unit 110 in the selected region(s) v62 in the page data v60 being displayed. The data editing unit 112 stores the generated editing data and the acquired recording image in the editing data storage unit 114.

At this time, the data editing unit 112 may associate information associated with the selected region(s) v62 in the page data v60 with the acquired recording images.

### Step S116

On receiving an instruction relating to the uploading of a recording image from the user via the operation unit 13 (step S114, Yes), the data editing unit 112 reads the recording image in question from the editing data storage unit 114. The data editing unit 112 then generates the upload data d80 based on the read recording image and the information associated with the recording image.

Also, the data editing unit 112 may display an input interface for indicating access information for a network service via the display control unit 152 on the display unit 15. In this case, the data editing unit 112 acquires, from the operation unit 13, the access information for a network service inputted by the user.

The data editing unit 112 outputs the generated upload data d80 and the acquired access information for a network service to the editing data transmitting unit 116.

The editing data transmitting unit 116 acquires the upload data d80 and the access information for a network service from the data editing unit 112. The editing data transmitting unit 116 establishes a connection with the network service (that is, the external server 70) via the network n1 based on the acquired access information for the network service. Once a connection with the network service has been established, the editing data transmitting unit 116 uploads the upload data d80 to the network service.

Note that it should be obvious that so long as there has been no instruction relating to the uploading of recording images (step S114, No), it is not necessary to carry out processing relating to step S116.

### 4. EXAMPLE HARDWARE CONFIGURATION

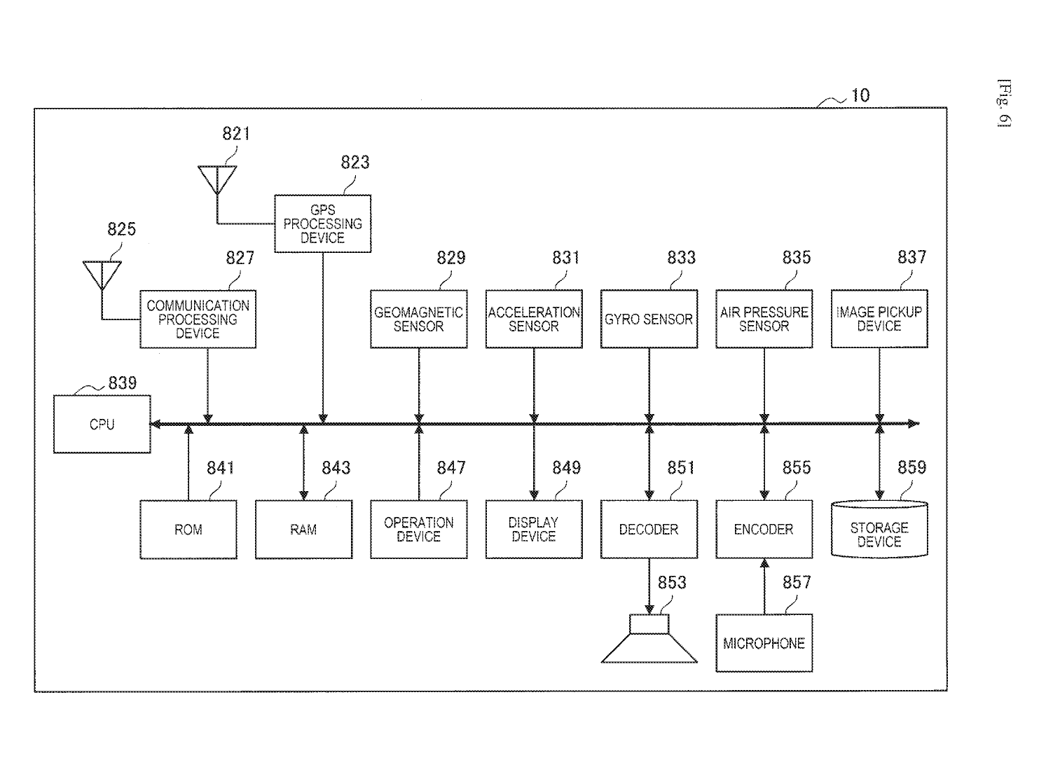

The information processing by the information processing apparatus 10 according to an embodiment of the disclosure described above is realized by cooperative operation of hardware of the information processing apparatus 10, such as that described below, and software. One example of the hardware configuration of the information processing apparatus 10 is described below with reference to FIG. 6. FIG. 6 is a block diagram showing an example hardware configuration of the information processing apparatus 10.

As one example, the information processing apparatus 10 includes a GPS antenna 821, a GPS processing device 823, a communication antenna 825, a communication processing device 827, a geomagnetic sensor 829, an acceleration sensor 831, a gyro sensor 833, an air pressure sensor 835, an image pickup device 837, a CPU (Central Processing Unit) 839, a ROM (Read Only Memory) 841, a RAM (Random Access Memory) 843, an operation device 847, a display device 849, a decoder 851, a speaker 853, an encoder 855, a microphone 857, and a storage device 859.

The GPS antenna 821 is an example of an antenna that receives signals from positioning satellites. The GPS antenna 821 is capable of receiving GPS signals from a plurality of GPS satellites and inputting the received GPS signals into the GPS processing device 823.

The GPS processing device 823 is one example of a calculation unit that calculates positioning information based on the signals received from positioning satellites. The GPS processing device 823 calculates present position information based on the plurality of GPS signals inputted from the GPS antenna 821 and outputs the calculated position information. More specifically, the GPS processing device 823 calculates the positions of the respective GPS satellites from trajectory data of the GPS satellites and calculates the distance from each GPS satellite to the present information processing apparatus based on the time difference between the transmission time and reception time of GPS signals. It is also possible to calculate a present three-dimensional position based on the calculated positions of the respective GPS satellites and the distances from the respective GPS satellites to the information processing apparatus. Note that the trajectory data of the GPS satellites used here may be included in the GPS signals, for example. Alternatively, the trajectory data of the GPS satellites may be acquired from an external server via the communication antenna 825.

The communication antenna 825 is an antenna with a function for receiving a communication signal via a mobile communication network or a wireless LAN (Local Area Network) communication network, for example. The communication antenna 825 is capable of supplying a received signal to the communication processing device 827.

The communication processing device 827 includes a function of carrying out various types of signal processing on a signal supplied from the communication antenna 825. The communication processing device 827 is capable of supplying a digital signal generated from the supplied analog signal to the CPU 839.

The geomagnetic sensor 829 is a sensor that detects geomagnetism as a voltage value. The geomagnetic sensor 829 may be a triaxial geomagnetic sensor that detects geomagnetism in an X axis direction, a Y axis direction, and Z axis direction, respectively. The geomagnetic sensor 829 is capable of supplying the detected geomagnetic sensor data to the CPU 839.

The acceleration sensor 831 is a sensor that detects acceleration as a voltage value. The acceleration sensor 831 may be a triaxial acceleration sensor that detects acceleration along the X axis direction, acceleration along the Y axis direction, and acceleration along the Z axis direction, respectively. The acceleration sensor 831 supplies the detected acceleration data to the CPU 839.

The gyro sensor 833 is a type of measuring instrument that measures the angle and/or angular velocity of an object. The gyro sensor 833 may be a triaxial gyro sensor that detects a velocity (angular velocity) that changes a rotational angle around the X axis, the Y axis, and the Z axis as a voltage value. The gyro sensor 833 is capable of supplying the detected angular velocity data to the CPU 839.

The air pressure sensor 835 is a sensor that detects ambient air pressure as a voltage value. The air pressure sensor 835 is capable of detecting air pressure with a specified sampling frequency and supplying the detected air pressure data to the CPU 839.

The image pickup device 837 has a function of picking up still images or moving images via a lens in accordance with control of the CPU 839. The image pickup device 837 may store the picked up images in the storage device 859.

The CPU 839 functions as a computational processing apparatus and a control apparatus, and controls the entire operations inside the information processing apparatus 10 in accordance with various programs. The CPU 839 may be a microprocessor. Such CPU 839 is capable of realizing various functions in accordance with the various programs. Note that the operation of the content acquiring unit 102, the content analyzing unit 106, the image acquiring unit 108, the image processing unit 110, the data editing unit 112, the display control unit 152, and the editing data transmitting unit 116 are realized by the CPU 839 executing a program in which the operations of such various configurations are defined.

The ROM 841 is capable of storing a program, computation parameters, and the like used by the CPU 839. The RAM 843 is capable of temporarily storing a program to be used in execution by the CPU 839 and parameters and the like that change as appropriate during such execution.

The operation device 847 has a function of generating an input signal for carrying out a desired operation of the user. The operation device 847 may be constructed of an input unit, such as a touch sensor, mouse, keyboard, button or button(s), microphone, switch or switches, or lever or levers, for enabling the user to input information, an input control circuit that generates an input signal based on an input made by the user and outputs to the CPU 839, and the like.

The display device 849 is one example of an output apparatus and may be a display apparatus such as a liquid crystal display (LCD) apparatus or an organic EL (OLED: Organic Light Emitting Diode) display apparatus. The display device 849 is capable of providing information by displaying screens to the user.

The decoder 851 has a function of carrying out decoding, analog conversion, and the like on inputted data in accordance with control by the CPU 839. As one example, the decoder 851 carries out decoding, analog conversion, and the like of audio data that has been inputted via the communication antenna 825 and the communication processing device 827 and outputs an audio signal to the speaker 853. The speaker 853 is capable of outputting audio based on the audio signal supplied from the decoder 851.

The encoder 855 has a function of carrying out digital conversion, encoding, and the like on inputted data in accordance with control by the CPU 839. The encoder 855 is capable of carrying out digital conversion, encoding, and the like of an audio signal inputted from the microphone 857 and outputting audio data. The microphone 857 is capable of picking up audio and outputting as an audio signal.

The storage device 859 is an apparatus for storing data and can include a storage medium, a recording apparatus that records data onto a storage medium, a reading apparatus that reads data from a storage medium, a deleting device that deletes data recorded on a storage medium, and the like. As the storage medium, as examples it is possible to use a nonvolatile memory such as a flash memory, MRAM (Magnetoresistive Random Access Memory), FeRAM (Ferroelectric Random Access Memory), PRAM (Phase change Random Access Memory) and EEPROM (Electronically Erasable and Programmable Read Only Memory) or a magnetic recording medium such as an HDD (Hard Disk Drive).

As one example, the display unit described above may be an HMD (Head Mounted Display). As one example, if a non-transmissive HMD is used as the display unit, it is not necessary to display picked-up images on the display unit. In such case, the display unit may superimpose virtual objects on a real space instead of displaying picked-up images.

It is also possible to produce a program for causing hardware such as the CPU, ROM, and RAM incorporated in a computer to achieve the same functions as the configuration of the information processing apparatus described above. It is also possible to provide a computer-readable recording medium on which such a program has been recorded.

### 5. CONCLUSION

As described above, the information processing apparatus 10 according to an embodiment is configured so that images that have been picked up by the image pickup apparatus 30 can be disposed in one or more regions v62 in the page data v60 displayed on the display unit 15. By using this configuration it is possible for the user to generate and view editing data in which images picked up by the user himself/herself have been disposed in a layout into which the electronic book content d24 has been arranged. In other words, according to the information processing apparatus 10 according to an embodiment, it is possible to reflect, as an experience of the user, images picked up by the user in content provided by the electronic book content d24.

Also, with the information processing apparatus 10 according to an embodiment, the page data v60 (preview image) displayed on the display unit 15 is updated in real time in synchronization with an image pickup operation by the image pickup apparatus 30. Also, if the user has designated the content of image processing, the information processing apparatus 10 reflects the content of the image processing indicated by the user in real time in the image displayed in the selected region(s) v62 in the page data v60. This means that it becomes possible for the user to adjust the image pickup angle and the content of image processing while confirming the page data v60 where images based on an image pickup process by the image pickup apparatus 30 have been disposed in the desired region(s) v62 in the page data v60 and to give an image pickup instruction to the information processing apparatus 10.

Also, the information processing apparatus 10 according to an embodiment generates the upload data d80 based on the recording images and information associated with such recording images and uploads the generated upload data d80 to a network service. This means that it becomes possible when uploading recording image(s) (that is, images that have been picked up) to a network service, it is possible to reduce the burden of the user in generating other data, such as a comment, aside from the recording image(s).

Also, with the information processing apparatus 10 according to an embodiment, information associated with a region v62 in the page data v60 in which a recording image is disposed is further associated with such recording image. This means that according to the information processing apparatus 10 according to an embodiment, it is possible to automatically generate the upload data d80 in accordance with a content written as an article in the electronic book content d24.

Note that although an example where the electronic book content d24 is provided as a so-called “book”, such as a travel magazine or a cookery magazine, has been described, as another example it is also possible to apply the present disclosure to electronic book content d24 where only regions v62 in which photographs are to be disposed are arranged in a specified layout. By applying the present disclosure to such electronic book content d24 to make it possible to dispose images picked up by the user, it is possible to use the electronic book content d24 as a simple album, for example.

Although embodiments of the present disclosure have been described above with reference to the attached drawings, the technical scope of the present disclosure is not limited to such embodiments. It should be understood by those skilled in the art that various modifications, combinations, sub-combinations and alterations may occur depending on design requirements and other factors insofar as they are within the scope of the appended claims or the equivalents thereof.

The effects described in the present specification are indicated merely for explanatory and illustrative purposes and the effects of the present disclosure are not limited to those given herein. That is, in addition to or in place of the effects given above, the technology according to the present disclosure may have other effects that are apparent to those of skill in the art from the disclosure of this specification.

The present technology may be embodied as the following configurations, but is not limited thereto.

(1) An information processing apparatus including:

a circuitry configured to:
initiate a displaying of a content upon a display; and
initiate an insertion of an acquired image into a region of the displayed content, the acquired image being selected on a basis of at least one image of a plurality of successive images that has been acquired and displayed.
   (2) The information processing apparatus of (1), wherein the region of the displayed content is represented by a sub frame and the acquired image is inserted into an area within the sub frame.
   (3) The information processing apparatus of (1) or (2), wherein the acquired image is inserted into the region of the displayed content by changing a display of an existing image of the displayed content so as to have the acquired image being displayed.
   (4) The information processing apparatus of any of (1) through (3), wherein the region of the displayed content is a selectable region that is selected by a user for the insertion of the acquired image.
   (5) The information processing apparatus of any of (1) through (4), wherein the acquired image is an image captured by a camera.
   (6) The information processing apparatus of any of (1) through (5), wherein a plurality of acquired images are successively inserted into the region of the displayed content.
   (7) The information processing apparatus of any of (1) through (6), wherein the plurality of acquired images are frames of a video.
   (8) The information processing apparatus of any of (1) through (7), wherein the acquired image is associated with the region of the displayed content or with an existing image of the displayed content positioned within the region.
   (9) The information processing apparatus of any of (1) through (8), wherein the circuitry is further configured to initiate a capturing of the acquired image.
   (10) The information processing apparatus of any of (1) through (9), wherein the content is a digital content obtained from a web page or a digital document.
   (11) The information processing apparatus of any of (1) through (10), wherein the circuitry is further configured to initiate a displaying of an instruction interface which allows for receipt of input instructions to modify the inserted acquired image.
   (12) The information processing apparatus of any of (1) through (11), wherein the instruction interface provides the instruction interface for performing an editing process upon the acquired image.
   (13) The information processing apparatus of any of (1) through (12), wherein the editing process comprises at least one of an enlargement processing, a color information processing, and a trimming processing.
   (14) The information processing apparatus of any of (1) through (13), wherein the circuitry is further configured to initiate a transmission of the displayed content having the acquired image inserted therein to another apparatus through a network.
   (15) The information processing apparatus of any of (1) through (14), wherein

the plurality of successive images is captured and displayed substantially in real-time within the region of the displayed content prior to the insertion of the acquired image,

the acquired image corresponds to a selected frame of the plurality of successive images, and

the circuitry initiates the insertion of the acquired image for display in place of the displayed plurality of successive images.

(16) The information processing apparatus of any of (1) through (15), wherein the acquired image and the plurality of successive images are captured with different conditions.
(17) The information processing apparatus of any of (1) through (16), wherein the plurality of successive images are of a lower image resolution than the acquired image.
(18) The information processing apparatus of any of (1) through (17), wherein the acquired image and the selected frame of the plurality of successive images have different image characteristics.
(19) The information processing apparatus of any of (1) through (18), further including:

a camera configured to capture the acquired image.

(20) The information processing apparatus of any of (1) through (19), wherein, upon a selection by a user of a selected frame of the plurality of successive images, the circuitry initiates a capturing of the acquired image and the insertion of the acquired image into the region of the displayed content, and

wherein the acquired image corresponds to the selected frame of the plurality of successive images.

(21) The information processing apparatus of any of (1) through (20), wherein the acquired image is of a higher resolution that the selected frame of the plurality of successive images.
(22) The information processing apparatus of any of (1) through (21), wherein the plurality of successive images is displayed within the region of the displayed content prior to the insertion of the acquired image.
(23) The information processing apparatus of any of (1) through (22), wherein the acquired image corresponds to a selected frame of the plurality of successive images, and the acquired image is of a different condition than other frames of the plurality of successive images not the selected frame.
(24) An information processing method including:

initiating a displaying of a content upon a display; and

initiating an insertion of an acquired image into a region of the displayed content, the acquired image being selected on a basis of at least one image of a plurality of successive images that has been acquired and displayed.

(25) A non-transitory computer-readable medium having embodied thereon a program, which when executed by a computer causes the computer to perform a method, the method including:

initiating a displaying of a content upon a display; and

initiating an insertion of an acquired image into a region of the displayed content, the acquired image being selected on a basis of at least one image of a plurality of successive images that has been acquired and displayed.

Additionally, the present technology may also be configured as below.

(1)
An information processing apparatus including:
a content acquiring unit configured to acquire electronic book content that is divided into a plurality of regions; and
a data editing unit configured to dispose, in at least one region out of the plurality of regions in the electronic book content, images successively acquired based on an image pickup operation being carried out by an image pickup apparatus.
(2)
The information processing apparatus according to (1), further including
a display control unit configured to have the electronic book content displayed and to update a display of the electronic book content based on disposing of the images in the one region.
(3)
The information processing apparatus according to (2),
wherein the data editing unit is configured to receive an instruction relating to image pickup and to record an image corresponding to timing at which the instruction was received, out of the images that are successively acquired, and
wherein a resolution of the images displayed by being disposed in the one region and a resolution of the image recorded after the instruction are different.
(4)
The information processing apparatus according to (1),
wherein the data editing unit is configured to receive an instruction relating to image pickup and to record an image corresponding to timing at which the instruction was received, out of the images that are successively acquired.
(5)
The information processing apparatus according to (3) or (4),
wherein the data editing unit is configured to record the image corresponding to the timing at which the instruction was received in association with information showing a location at which the image was picked up.
(6)
The information processing apparatus according to any one of (1) to (5), further including
an image processing unit configured to carry out image processing on the acquired images,
wherein the data editing unit is configured to dispose the images on which image processing has been carried out in the one region.
(7)
The information processing apparatus according to (6),
wherein the data editing unit is configured to display an interface for indicating a content of the image processing.
(8)
The information processing apparatus according to (6) or (7),
wherein the image processing includes processing for at least one of changing an enlargement ratio of the images, changing color information in the images, and cutting out part of the images.
(9)
The information processing apparatus according to any one of (1) to (8),
wherein the electronic book content is made up of a plurality of page data,
wherein each of the plurality of page data is divided into the at least one region, and
wherein the data editing unit is configured to dispose the images in at least one region in page data that is to be displayed out of the plurality of page data.
(10)
The information processing apparatus according to (9),
wherein the data editing unit is operable when the page data that is to be displayed has changed, to dispose the images in at least one region in the changed-to page data.
(11)
The information processing apparatus according to any one of (1) to (10),
wherein the one region is associated with other information that differs to information which is associated in advance with the one region as information to be displayed, and wherein the information processing apparatus further includes a transmitting unit configured to associate the other information associated with the one region with the acquired images and to transmit to a network service.
(12)
The information processing apparatus according to (11),
wherein the other information associated with the one region is configured so as to be switchable in accordance with image pickup conditions of the images.
(13)
The information processing apparatus according to (12),
wherein the other information associated with the one region is configured so as to be switchable in accordance with a location where images were picked up.
(14)
The information processing apparatus according to any one of (11) to (13),
wherein the other information includes at least information which is associated in advance with another region that differs to the one region as information to be displayed.
(15)
An information processing method including:
acquiring electronic book content that is divided into a plurality of regions; and
disposing, using a processor, images successively acquired based on an image pickup operation being carried out by an image pickup apparatus in at least one region out of the plurality of regions in the electronic book content.
(16)
A program causing a computer to execute:
a function of acquiring electronic book content that is divided into a plurality of regions; and
a function of disposing images successively acquired based on an image pickup operation being carried out by an image pickup apparatus in at least one region out of the plurality of regions in the electronic book content.

### REFERENCE SIGNS LIST

1 information processing system
10 information processing apparatus 10
102 content acquiring unit
104 content storage unit
106 content analyzing unit
108 image acquiring unit
110 image processing unit
112 data editing unit
114 editing data storage unit
116 editing data transmitting unit
13 operation unit
15 display unit
152 display control unit
30 image pickup apparatus
50 content distribution server
70 external server

1. An information processing apparatus comprising:
a circuitry configured to:
initiate a displaying of a content upon a display; and
initiate an insertion of an acquired image into a region of the displayed content, the acquired image being selected on a basis of at least one image of a plurality of successive images that has been acquired and displayed.

2. The information processing apparatus of claim 1, wherein the region of the displayed content is represented by a sub frame and the acquired image is inserted into an area within the sub frame.

3. The information processing apparatus of claim 1, wherein the acquired image is inserted into the region of the displayed content by changing a display of an existing image of the displayed content so as to have the acquired image being displayed.

4. The information processing apparatus of claim 1, wherein the region of the displayed content is a selectable region that is selected by a user for the insertion of the acquired image.

5. The information processing apparatus of claim 1, wherein the acquired image is an image captured by a camera.

6. The information processing apparatus of claim 1, wherein a plurality of acquired images are successively inserted into the region of the displayed content.

7. The information processing apparatus of claim 6, wherein the plurality of acquired images are frames of a video.

8. The information processing apparatus of claim 1, wherein the acquired image is associated with the region of the displayed content or with an existing image of the displayed content positioned within the region.

9. The information processing apparatus of claim 1, wherein the circuitry is further configured to initiate a capturing of the acquired image.

10. The information processing apparatus of claim 1, wherein the content is a digital content obtained from a web page or a digital document.

11. The information processing apparatus of claim 1, wherein the circuitry is further configured to initiate a displaying of an instruction interface which allows for receipt of input instructions to modify the inserted acquired image.

12. The information processing apparatus of claim 11, wherein the instruction interface provides the instruction interface for performing an editing process upon the acquired image.

13. The information processing apparatus of claim 12, wherein the editing process comprises at least one of an enlargement processing, a color information processing, and a trimming processing.

14. The information processing apparatus of claim 1, wherein the circuitry is further configured to initiate a transmission of the displayed content having the acquired image inserted therein to another apparatus through a network.

15. The information processing apparatus of claim 1, wherein
the plurality of successive images is captured and displayed substantially in real-time within the region of the displayed content prior to the insertion of the acquired image,
the acquired image corresponds to a selected frame of the plurality of successive images, and
the circuitry initiates the insertion of the acquired image for display in place of the displayed plurality of successive images.

16. The information processing apparatus of claim 15, wherein the acquired image and the plurality of successive images are captured with different conditions.

17. The information processing apparatus of claim 15, wherein the plurality of successive images are of a lower image resolution than the acquired image.

18. The information processing apparatus of claim 15, wherein the acquired image and the selected frame of the plurality of successive images have different image characteristics.

19. The information processing apparatus of claim 1, further comprising:
a camera configured to capture the acquired image.

20. The information processing apparatus of claim 1, wherein, upon a selection by a user of a selected frame of the plurality of successive images, the circuitry initiates a capturing of the acquired image and the insertion of the acquired image into the region of the displayed content, and
wherein the acquired image corresponds to the selected frame of the plurality of successive images.

21. The information processing apparatus of claim 20, wherein the acquired image is of a higher resolution that the selected frame of the plurality of successive images.

22. The information processing apparatus of claim 20, wherein the plurality of successive images is displayed within the region of the displayed content prior to the insertion of the acquired image.

23. The information processing apparatus of claim 1, wherein the acquired image corresponds to a selected frame of the plurality of successive images, and the acquired image is of a different condition than other frames of the plurality of successive images not the selected frame.

24. An information processing method comprising:
initiating a displaying of a content upon a display; and
initiating an insertion of an acquired image into a region of the displayed content, the acquired image being selected on a basis of at least one image of a plurality of successive images that has been acquired and displayed.

25. A non-transitory computer-readable medium having embodied thereon a program, which when executed by a computer causes the computer to perform a method, the method comprising:
initiating a displaying of a content upon a display; and
initiating an insertion of an acquired image into a region of the displayed content, the acquired image being selected on a basis of at least one image of a plurality of successive images that has been acquired and displayed.
